(19) United States
(12) Patent Application Publication
(10) Pub. No.: US 2021/0050130 A1
(43) Pub. Date: Feb. 18, 2021

(54) Cable comprising a fire-resistant layer

(71) Applicant: NEXANS, Courbevoie (FR)

(72) Inventor: Christophe BRISMALEIN, LIEVIN (FR)

(21) Appl. No.: 16/924,882

(22) Filed: Jul. 9, 2020

(30) Foreign Application Priority Data
Jul. 12, 2019 (FR) 19 07865

(51) Int. Cl. H01B 7/295; H01B 13/00; H01B 3/10; H01B 3/08

(52) U.S. Cl. CPC H01B 7/295; H01B 13/0016; H01B 13/16; H01B 3/08; H01B 3/10

(57) ABSTRACT

A cable including at least one elongated conductive element and at least one fire-resistant insulating layer in direct physical contact with the elongated electrically conductive element, the fire-resistant layer is obtained by heat treatment of a liquid inorganic composition.

### RELATED APPLICATION

This application claims the benefit of priority from French Patent Application No. 19 07865, filed on Jul. 12, 2019, the entirety of which is incorporated by reference.

### BACKGROUND

### Field of the Invention

The present invention relates to a power cable comprising at least one elongated conductive element and at least one fire-resistant insulating layer, and also to the process for preparing such a cable.

The invention typically but not exclusively applies to fire-resistant safety cables which are capable of functioning for a given period of time under fire conditions, without, however, propagating the fire or generating substantial fumes. These safety cables are in particular low-voltage or medium-voltage (notably from 6 to 45-60 kV) cables such as power transportation or transmission cables, for instance control or signalling cables.

### Description of Related Art

A power cable is a cable intended for transporting electrical energy. It conventionally comprises one or more insulated conductive elements, in other words one or more elongated electrical conductors surrounded with at least one insulating layer. The insulating layer may typically be an electrically insulating polymer layer in physical contact with the electrical conductor(s). Said insulated conductive element(s) are generally surrounded with an outer protective sheath for mechanically protecting the insulated conductive element(s).

The materials that may be used for forming the insulating layer are generally composite materials based on polymers, in particular silicone polymers, and on various additives, notably reinforcing fillers such as silica.

Although these materials do in principle have good mechanical and dielectric properties, they are not, however, fire-resistant and they melt rapidly under the effect of the high temperatures generated during fires.

Now, according to the fire resistance standard IEC 60331, “fire-resistant” cables are cables that are configured to be able to continue to function with acceptable performance even if, in the event of a fire, they are directly exposed to flames for a certain time, at temperatures of from 750° C. to 900° C. or even at higher temperatures.

Cables including a fire-resistant insulating layer have already been proposed, notably in the international patent application WO 2017/199060, which describes a fire-resistant cable comprising an elongated conductive element surrounded with a layer of a ceramifiable composition comprising a specific mixture of thermoplastic polymers comprising (a) a copolymer of ethylene and of an α-olefin with a density of from 0.860 to 0.910 g/cm³, a melt flow index (MFI) not exceeding 3 g/10 minutes and a melting point of at most 105° C., (b) an ethylene homopolymer or a copolymer of ethylene and of an α-olefin with a density of from 0.900 to 0.985 g/cm³, a melt flow index (MFI) not exceeding 5 g/10 minutes and a melting point of at most 110° C., and (c) a polyethylene substituted with a monomer including an ethylenic unsaturation; at least 25% by weight of silica; a fluxing agent chosen from alkali metal oxides and precursors thereof; an inorganic hydroxide such as magnesium hydroxide, aluminium hydroxide and mixtures thereof; and at least 5% by weight of a stabilizer based on hydrated magnesium silicate. This composition is generally used by extrusion in the form of a layer having a thickness of several millimetres. This ceramifiable layer can constitute the outer layer of the cable (outer sheath) or the filling material (or “bedding”) between the insulated conductive elements and the outer sheath. When this ceramifiable layer is exposed to high temperatures such as those caused by fires, it reacts to form a fire-resistant ceramic layer.

Cables including such a layer have good fire resistance but, however, have a large diameter given the thickness of the ceramifiable layer.

### OBJECTS AND SUMMARY

The aim of the present invention is to provide a cable which has good fire resistance while at the same time having a smaller diameter than the cables of the prior art, notably by means of the presence of a fire-resistant layer having a small thickness.

A first subject of the present invention is a cable comprising at least one elongated electrically conductive element and at least one fire-resistant layer surrounding said elongated electrically conductive element, said cable being characterized in that said fire-resistant layer is in direct physical contact with said elongated electrically conductive element, and in that said fire-resistant layer is obtained by heat treatment of a liquid inorganic composition. Preferably, the liquid inorganic composition may be solidified by means of the heat treatment: this is then referred to as a fire-resistant layer obtained by solidification of the liquid inorganic composition.

For the purposes of the present invention, the expression “in direct physical contact” means that no layer, of any nature whatsoever, is intercalated between said elongated electrically conductive element and said fire-resistant layer. In other words, the cable does not comprise any intermediate layer(s), notably any layer(s) comprising at least one polymer, positioned between said elongated electrically conductive element and said fire-resistant layer.

A “passivation” layer formed by oxidation, for example with air or by surface treatment of the elongated electrically conductive element, is not considered as a layer intercalated or positioned between said elongated electrically conductive element and said fire-resistant layer. In other words, the elongated electrically conductive element may comprise a passivation layer. As a result, the fire-resistant layer may be in direct physical contact with the passivation layer of the elongated electrically conductive element.

The heat treatment of the liquid inorganic composition, or more particularly the solidification of the liquid inorganic composition, may be performed at a temperature of at most about 300° C., preferably at a temperature chosen within a range extending from about 90° C. to 300° C., and even more preferentially at a temperature chosen within a range extending from about 200° C. to 300° C.

The duration of the heat treatment varies as a function of the temperature at which said treatment is performed. However, when the heat treatment is performed at a temperature of between about 95° C. and 300° C., the duration of the heat treatment typically ranges from 1 second (s) to 2 hours (h), and preferentially from 15 s to 5 minutes (min), notably for a continuous application.

By way of example, the heat treatment may comprise one or more cycles chosen from 95° C. for 2 hours, 25° C. for 30 minutes, 95° C. for 10 minutes, 150° C. for 1 minute, 200° C. for 15 seconds, 250° C. for 5 seconds, 250° C. for 30 seconds, and a combination thereof.

The liquid inorganic composition is notably a fire-resistant composition. It is preferably a composition comprising at least one transition metal oxide, at least one aluminosilicate and at least one solvent, the solvent notably enabling a liquid composition to be obtained. The solvent may advantageously be evaporated off during the heat treatment of the liquid inorganic composition.

It may also comprise at least one other silicate different from said aluminosilicate, for instance a sodium silicate, a calcium silicate or a potassium silicate.

According to a preferred embodiment of the invention, the liquid inorganic composition comprises at least about 10% by weight of at least one transition metal oxide, and even more preferentially from about 15% to 60% by weight of at least one transition metal oxide, said percentages being expressed relative to the total weight of said composition.

The transition metal oxide is preferably zirconium oxide.

According to a preferred embodiment of the invention, the liquid inorganic composition comprises at least about 2% by weight of at least one aluminosilicate, and even more preferentially from about 5% to 20% by weight of at least one aluminosilicate, said percentages being expressed relative to the total weight of said composition.

The aluminosilicate(s) are preferably chosen from phyllosilicates, for instance mica or kaolin; and tectosilicates, for instance feldspar or zeolite.

According to a preferred embodiment of the invention, the liquid inorganic composition comprises at least about 10% by weight of at least one solvent, and even more preferentially from about 20% to 75% by weight of at least one solvent, said percentages being expressed relative to the total weight of said composition.

As a preferred example, the solvent may be water. When the solvent used in the liquid inorganic composition is water, the liquid inorganic composition is an aqueous composition.

According to a preferred embodiment of the invention, the liquid inorganic composition may also comprise at least about 10% by weight of at least one other silicate different from said aluminosilicate, and even more preferentially from about 15% to 40% by weight of at least one other silicate different from said aluminosilicate, said percentages being expressed relative to the total weight of said composition.

In a particularly advantageous embodiment, the liquid inorganic composition may also comprise at least one plasticizer.

More particularly, the liquid inorganic composition may comprise from 0.01% to 10.0% by weight of plasticizer, preferably from 0.01% to 5.0% by weight of plasticizer, preferably from 0.1% to 2.0% by weight of plasticizer and particularly preferably from 0.1% to 1.0% by weight of plasticizer, said percentages being expressed relative to the total weight of said composition.

The plasticizer may advantageously be added to the liquid inorganic composition to improve the folding endurance of the fire-resistant layer, or, in other words, to significantly limit, or even to prevent, fissures or cracks during the bending of the cable of the invention.

The plasticizer may be chosen from a polyol, a low molecular weight polymer, ammonium chloride, a carbohydrate, a clay, and a mixture thereof.

By way of example:
the polyol may be sorbitol;
the low molecular weight polymer may be an oligomer containing from 2 to 40 and preferably from 2 to 20 identical or different monomer units, and/or a polymer with a molecular weight of at most 50 000 g/mol and preferably at most 20 000 g/mol, the low molecular weight polymer being, for example, a polyethylene glycol;
the clay may be a phyllosilicate;
the carbohydrate may be cellulose.

According to a particularly preferred embodiment of the invention, said liquid inorganic composition is an aqueous composition comprising from about 15% to 45% by weight of zirconium oxide, from about 5% to 20% by weight of aluminosilicate, and from about 15% to 35% by weight of another silicate different from said aluminosilicate, the rest of the composition being water. Such a composition is sold under the trade name Pyropaint® 634-ZO by the company Aremco (New York, USA) and distributed by the company Polytec France (Chatillon, France).

The liquid inorganic composition preferably has a viscosity ranging from about 10⁻³ to 2×10⁻³ m²/s (1000 to 2000 centistokes approximately), and even more preferentially from about 10⁻³ to 1.4×10⁻³ m²/s (1000 to 1400 centistokes approximately), said viscosity being measured at a temperature of 25° C. using a No. 4 Ford viscosity cup, according to the standard ASTM D1200.

The fire-resistant layer of the invention may comprise at least one transition metal oxide and at least one aluminosilicate, and optionally at least one other silicate different from said aluminosilicate and/or at least one plasticizer, said transition metal oxide, said aluminosilicate, said other silicate and said plasticizer being as described above in the description.

More particularly, the fire-resistant layer may comprise:
at least about 25% by weight of at least one transition metal oxide, and preferably at most about 65% by weight of at least one transition metal oxide,
at least about 10% by weight of at least one aluminosilicate, and preferably at most about 25% by weight of at least one aluminosilicate,
optionally at least about 25% by weight of at least one other silicate different from said aluminosilicate, and preferably at most about 50% by weight of at least one other silicate different from said aluminosilicate, and
optionally at least about 0.01% by weight of at least one plasticizer, and preferably at most about 10% by weight of at least one plasticizer, the above percentages being expressed relative to the total weight of said fire-resistant layer.

The thickness of said fire-resistant layer preferably ranges from about 20 to 500 μm and even more preferentially from about 100 to 200 μm.

The thickness of said fire-resistant layer does not have any significant impact on the diameter of the cable, which is a great advantage in terms of design of the cable.

According to the invention, the expression “elongated electrically conductive element” means an electrically conductive element which has a longitudinal axis. In particular, the electrically conductive element is elongated because it has notably undergone at least one drawing step. Drawing conventionally comprises a step of cold deformation, notably through one or more dies.

The elongated conductive element is preferably made of copper, aluminium, a copper alloy or an aluminium alloy. According to a preferred embodiment of the invention, said conductive element does not comprise a nickel-based coating.

The cable in accordance with the present invention may comprise a plurality of elongated electrically conductive elements. In this case, each of the elongated electrically conductive elements is individually surrounded with at least one fire-resistant layer as defined previously, each of said layers being in direct physical contact with each of said elongated electrically conductive elements.

According to a particular and preferred embodiment of the present invention, the cable also comprises at least one polymer layer surrounding said fire-resistant layer.

Said polymer layer is preferably an electrically insulating layer.

According to the present invention, the expression “electrically insulating layer” means a layer whose electrical conductivity may be at most about 1×10⁻⁸ S/m (at 25° C. in DC).

According to a particularly preferred embodiment of the invention, the polymer layer comprises a polymer material chosen from crosslinked and non-crosslinked polymers, polymers of inorganic type and of organic type.

The polymer material may be in particular a homopolymer or a copolymer with thermoplastic and/or elastomeric properties.

The polymers of the inorganic type may be polyorganosiloxanes.

The polymers of the organic type may be polyolefins, polyurethanes, polyamides, polyesters, polyvinyls or halogenated polymers such as fluoropolymers (e.g. polytetrafluoroethylene PTFE) or chlorinated polymers (e.g. polyvinyl chloride PVC).

The polyolefins may be chosen from ethylene and propylene polymers. As examples of ethylene polymers, mention may be made of linear low-density polyethylenes (LLDPE), low-density polyethylenes (LDPE), medium-density polyethylenes (MDPE), high-density polyethylenes (HDPE), copolymers of ethylene and of vinyl acetate (EVA), copolymers of ethylene and of butyl acrylate (EBA), of methyl acrylate (EMA), of 2-ethylhexyl acrylate (2EHA), copolymers of ethylene and of α-olefins, for instance polyethylene-octene (PEO), copolymers of ethylene and of propylene (EPR), ethylene/ethyl acrylate (EEA) copolymers, or terpolymers of ethylene and of propylene (EPT), for instance ethylene-propylene-diene monomer (EPDM) terpolymers.

According to the present invention, the expression “low-density polyethylene” means a polyethylene with a density ranging from about 0.91 to 0.925.

According to the present invention, the expression “high-density polyethylene” means a polyethylene with a density ranging from about 0.94 to 0.965.

The polymer layer is preferably a layer extruded via techniques that are well known to those skilled in the art.

The cable in accordance with the present invention may also include a protective sheath and/or a metal shield. Said protective sheath may preferably be the outermost layer of said cable: it may then be referred to as the outer protective sheath. The protective sheath may surround the polymer layer(s), and the metal shield if such is included in the cable.

The protective sheath is preferably made of a halogen-free material. It may conventionally be made from materials which retard flame propagation or which withstand flame propagation. Notably, if the latter materials do not contain halogen, such sheathing is referred to as being of HFFR (halogen-free flame retardant) type.

It comprises at least one organic or inorganic polymer.

The choice of the organic or inorganic polymer is not limiting and these polymers are well known to those skilled in the art.

According to a preferred embodiment of the invention, the organic or inorganic polymer is chosen from crosslinked and non-crosslinked polymers.

The organic or inorganic polymer may be a homopolymer or a copolymer with thermoplastic and/or elastomeric properties.

The inorganic polymers may be polyorganosiloxanes.

The organic polymers may be polyurethanes or polyolefins identical to those defined above for the electrically insulating polymer layer.

The polymer of said sheath is preferably an organic polymer, more preferably an ethylene polymer, and more preferably a copolymer of ethylene and of vinyl acetate, a linear low-density polyethylene or a mixture thereof.

The protective sheath may also comprise a hydrated flame-retardant mineral filler. This hydrated flame-retardant mineral filler acts mainly physically by decomposing endothermically (e.g. release of water), the consequence of which is to lower the temperature of the sheath and to limit the propagation of flames along the cable. This is notably referred to as flame-retardant properties.

The hydrated flame-retardant mineral filler may be a metal hydroxide such as magnesium hydroxide or aluminium trihydroxide.

The protective sheath may also comprise an inert filler, notably chosen from talc, micas, dehydrated clays and a mixture thereof.

In a particular embodiment, the cable according to the present invention may comprise:
several elongated electrically conductive elements, each of said elongated electrically conductive elements being surrounded with one or more fire-resistant layers in accordance with the invention,
an electrically insulating layer, notably as described above, surrounding each elongated electrically conductive element together with the fire-resistant layer(s), and
a protective sheath, notably as described above, surrounding all of the constituent elements of the cable.

A subject of the present invention is also a process for preparing the cable as defined previously, i.e. a cable comprising at least one elongated electrically conductive element and at least one fire-resistant layer surrounding said elongated electrically conductive element, said fire-resistant layer being in direct physical contact with said elongated electrically conductive element, said process being characterized in that it comprises at least:

i) a step of applying a liquid inorganic composition directly to the surface of at least one elongated electrically conductive element of said cable,
ii) a step of heat treatment of said liquid inorganic composition to form said fire-resistant layer.

According to a particular embodiment of the process in accordance with the present invention, steps i) and ii) may be repeated several times, typically two or three times. It is thus possible to vary the thickness of the fire-resistant layer.

Step i) of applying the liquid inorganic composition to the surface of the elongated electrically conductive element may be performed, for example, by immersing said element in said composition.

The heat treatment step ii) is preferably a step of solidification of the liquid inorganic composition. Said heat treatment brings about evaporation of the solvent for the liquid inorganic composition, and thus solidification of the inorganic composition.

As indicated previously, the heat treatment is preferably performed at a temperature of at most about 300° C., preferably at a temperature within a range extending from about 95° C. to 300° C., and particularly preferably at a temperature within a range extending from about 200° C. to 300° C.

The heat treatment may be performed using heating systems that are well known to those skilled in the art, for instance an ultraviolet, microwave, infrared or ceramic radiant heating system.

Before step i), the elongated electrically conductive element(s) may be subjected to one or more surface treatments. The surface treatment may notably be chosen from surface oxidation, degreasing, stripping, and a combination thereof. Surface oxidation may enable the production of a suitable radius of curvature for the elongated electrically conductive elements. The surface oxidation may be performed by acidic treatment of the elongated electrically conductive element(s), notably in the presence of an electric current. Degreasing may enable the removal of the drawing emulsion on the elongated electrically conductive element(s). The degreasing may be performed with an aqueous solution containing a base, for instance sodium hydroxide. Stripping may enable the surface of the elongated electrically conductive element(s) to be freed of oxide. The stripping may be performed with an aqueous solution containing an acid, for instance sulfuric acid.

### BRIEF DESCRIPTION OF THE DRAWINGS

The attached drawings illustrate the invention:

FIG. 1 schematically represents a structure, in cross section, of a cable in accordance with the invention according to a first embodiment.

FIG. 1 shows a cable (1) in accordance with the invention comprising an elongated electrically conductive element (2) and a fire-resistant layer (3) surrounding said elongated electrically conductive element (2), and being in direct physical contact with the elongated electrically conductive element (2). The elongated electrically conductive element (2) is notably a copper wire.

FIG. 2 schematically represents a structure, in cross section, of a cable in accordance with the invention according to a second embodiment.

FIG. 2 shows a cable (10) in accordance with the invention comprising the elongated electrically conductive element (2) and the fire-resistant layer (3) as described in FIG. 1, and also an electrically insulating layer (4) surrounding the fire-resistant layer (3). The electrically insulating layer (4) may be, for example, a layer of a polyethylene-based polymer material, formed notably by extrusion.

FIG. 3 schematically represents a structure, in cross section, of a cable in accordance with the invention according to a third embodiment.

FIG. 3 shows a cable (100) in accordance with the invention comprising several elongated electrically conductive elements (2), each elongated electrically conductive element (2) being successively surrounded with the fire-resistant layer (3) and the electrically insulating layer (4), each elongated electrically conductive element, fire-resistant layer and electrically insulating layer being as described in FIG. 2. The cable (100) also comprises a protective sheath (5) surrounding all of the constituent elements of the cable. The protective sheath (5) may be, for example, a layer of HFFR type polymer, formed notably by extrusion. The protective sheath may also surround a metal shield (not shown), said metal shield surrounding all of the constituent elements of the cable. The metal shield may be, for example, one or more metal strips, notably made of galvanized steel.

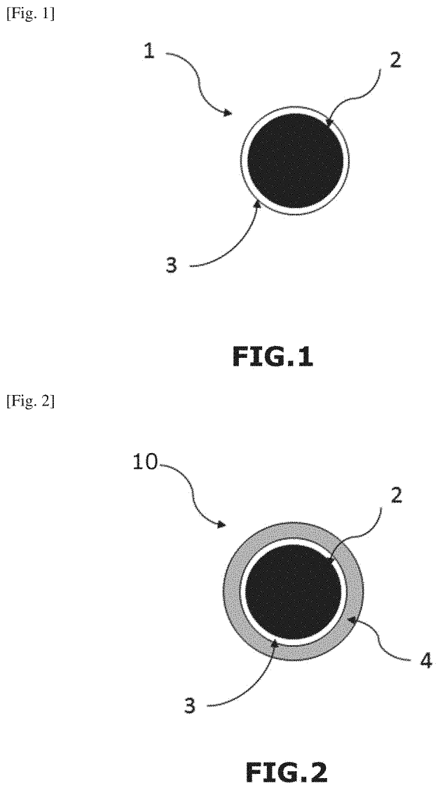

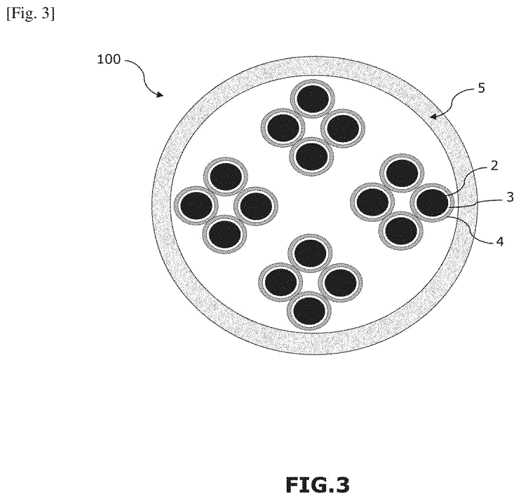

### DETAILED DESCRIPTION

Other characteristics and advantages of the present invention will emerge in the light of the examples that follow with reference to the annotated figures, said examples and figures being given for illustrative purposes and not being in any way limiting.

### EXAMPLES

### Example 1: Preparation of a Cable in Accordance with the Invention Including a Fire-Resistant Layer 150 μm Thick

A copper wire with a diameter of 1.2 mm was dipped in an aqueous solution with a viscosity of about 1.2×10⁻³ m²/s (1200 centistokes) (measured at a temperature of 25° C., using a No. 4 Ford viscosity cup, according to the standard ASTM D1200), sold by the company Aremco under the reference Pyropaint® 634-ZO, and then subjected to a heat treatment at a temperature of 250° C. for a time of 30 seconds, using a ceramic radiant heating system.

After the heat treatment, a cable covered with a fire-resistant white layer 50 μm thick was obtained.

The steps of dipping the copper wire in the Pyropaint® 634-ZO solution and of heat treatment were then repeated twice under the same conditions.

A cable covered with a fire-resistant white layer 150 μm thick was obtained.

### Example 2: High-Temperature Resistance Test

The cable obtained above in Example 1 was placed in a vertical oven heated at 830° C. for 30 minutes in order to test the resistance of the layer applied to the copper wire to exposure to a very high temperature.

After this test, it was observed that the fire-resistant layer had not suffered any degradation (no cracking) and that it thus efficiently protects the copper wire against the harmful effects of exposure to a very high temperature.

What is claimed is:

1. Cable comprising:
at least one elongated electrically conductive element; and
at least one fire-resistant layer surrounding said elongated electrically conductive element,
wherein said fire-resistant layer is in direct physical contact with said elongated electrically conductive element, and in that said fire-resistant layer is obtained by heat treatment of a liquid inorganic composition.

2. Cable according to claim 1, wherein the fire-resistant layer is obtained by solidification of the liquid inorganic composition.

3. Cable according to claim 1, wherein the heat treatment is performed at a temperature of at most 300° C.

4. Cable according to claim 1, wherein the liquid inorganic composition comprises at least one transition metal oxide, at least one aluminosilicate and at least one solvent.

5. Cable according to claim 4, wherein the liquid inorganic composition comprises at least 10% by weight of at least one transition metal oxide relative to the total weight of said composition.

6. Cable according to claim 4, wherein the transition metal oxide is zirconium oxide.

7. Cable according to claim 4, wherein the liquid inorganic composition comprises at least 2% by weight of at least one aluminosilicate relative to the total weight of said composition.

8. Cable according to claim 4, wherein the liquid inorganic composition comprises at least 10% by weight of at least one solvent relative to the total weight of said composition.

9. Cable according to claim 8, wherein the solvent is water.

10. Cable according to claim 4, wherein the liquid inorganic composition also comprises at least one other silicate different from said aluminosilicate.

11. Cable according to claim 4, wherein the liquid inorganic composition also comprises at least one plasticizer.

12. Cable according to claim 1, wherein the liquid inorganic composition has a viscosity ranging from 10⁻³ to 2×10⁻³ m²/s (1000 to 2000 centistokes), said viscosity being measured at a temperature of 25° C., using a No. 4 Ford viscosity cup, according to the standard ASTM D1200.

13. Cable according to claim 1, wherein the fire-resistant layer comprises at least one transition metal oxide and at least one aluminosilicate.

14. Cable according to claim 1, wherein the thickness of said fire-resistant layer ranges from 20 to 500 μm.

15. Cable according to claim 1, wherein the elongated conductive element is made of copper, aluminium, a copper alloy or an aluminium alloy.

16. Cable according to claim 1, wherein said cable further comprises a plurality of elongated electrically conductive elements, each of the elongated electrically conductive elements being individually surrounded with at least one fire-resistant layer, and in that each of said fire-resistant layers is in direct physical contact with each of said elongated electrically conductive elements.

17. Cable according to claim 1, wherein said cable also comprises at least one polymer layer (4) surrounding said fire-resistant layer.

18. Process for preparing a cable as defined in claim 1, wherein said method comprises at least:
i) a step of applying a liquid inorganic composition to the surface of at least one elongated electrically conductive element of said cable, and
ii) a step of heat treatment of said liquid inorganic composition to form said fire-resistant layer.

19. Process according to claim 18, wherein steps i) and ii) are repeated several times.
